(19) United States
(12) Patent Application Publication
(10) Pub. No.: US 2022/0238040 A1
(43) Pub. Date: Jul. 28, 2022

(54) INTERACTIVE EDUCATIONAL AID

(71) Applicant: University of South Carolina, Columbia, SC (US)

(72) Inventors: Sujit K. Pujhari, Columbia, SC (US); Sanjeeta Paul, Columbia, SC (US)

(73) Assignee: University of South Carolina, Columbia, SC (US)

(21) Appl. No.: 17/586,937

(22) Filed: Jan. 28, 2022

Related U.S. Application Data
(60) Provisional application No. 63/142,666, filed on Jan. 28, 2021.

(51) Int. Cl. G09B 23/26

(52) U.S. Cl. CPC G09B 23/26

(57) ABSTRACT

Described herein are interactive educational aid systems and devices for disseminating and communicating scientific concepts, such as an interactive educational tool plasmid for the study of molecular biology and genetic engineering concepts.

### TECHNICAL FIELD

The subject matter disclosed herein is generally directed to interactive educational aid systems and devices for disseminating and communicating scientific concepts, such as an interactive educational tool plasmid for the study of molecular biology and genetic engineering concepts

### BACKGROUND

Science and its varied facets are quite fascinating. For instance, the study of living organisms and their physiological reactions at the cellular and molecular level involves complex dynamic interactions. A comprehensive understanding of these internal cascade of events, reactions and/or mechanisms is pertinent in order to appreciate the complexity of living processes and to acquire knowledge.

Teaching methods, tools and resources are the key to this comprehensive understanding. However, most of the teaching/learning mode is textbook based that primarily delivers bookish knowledge and lacks the core fundamental understanding of the subject matter. Of late, illustrations, diagrams, flow charts and other interactive tools are being used to supplement textbook teaching/learning, but they have not been integrated fully to cater to the basic understanding of the scientific concepts.

This underutilization of illustrative models and interactive learning tools has created a lacuna in the accurate understanding of intricate life processes at the cellular and molecular level making it obvious in the part of the knowledge seekers to often get disinterested in the subject matter due to the lack of clarity and disconnect.

There is, hence, an unmet need for an interactive educational aid that will help knowledge seekers stay engaged and interested in the subject matter and simultaneously provide a comprehensive and clear understanding of the scientific concepts. There is also need in the art for an educational device that is a physical entity which is light weight and portable in nature thereby enhancing its efficiency and thus significantly increasing the likelihood of frequent usability.

Accordingly, it is an object of the present disclosure to provide an enhanced educational aid.

Citation or identification of any document in this application is not an admission that such a document is available as prior art to the present disclosure.

### SUMMARY

The above objectives are accomplished according to the present disclosure by providing in one embodiment, an interactive plasmid-based educational device. The device may include a circular base, at least one first contoured shaped section having at least one end configured with at least one matching geometry, at least one second contoured shaped section having at least one end configured with at least one universal joining geometry, the at least first contoured shaped section and the at least one second contoured shaped section are configured to mimic at least one portion of a plasmid, at least one audio circuit, at least one visual circuit, wherein the at least first contoured shaped section and the at least second contoured shaped section contain at least a portion of the at least one audio circuit and the at least one visual circuit; the circular base configured to support the at least one first contoured shaped section and the at least one second contoured section joined to one another; and when joined, the at least one first contoured shaped section and the at least one second contoured shaped section complete at least one of the audio circuit or the visual circuit. Further, the audio circuit provides a positive affirmation for correct assembly of the at least one first contoured shaped section and the at least second contoured shaped section and provides a negative indication for incorrect assembly of the at least one first contoured shaped section and the at least second contoured shaped section. Still yet, the video circuit provides a positive indication for correct assembly and a negative indication for incorrect assembly. Again, the at least one third contoured shaped section has at least one first end with at least one matching geometry and at least one second end with at least one universal joining geometry. Still moreover, the base may also contain at least another portion of the at least one audio circuit and the at least one visual circuit. Even further, the at least one audio circuit may provide an auditory explanation of a particular plasmid portion represented by the at least one first contoured shaped section or the at least one second contoured shaped section when placed upon the circular base.

In a further embodiment, a method for instruction regarding plasmid construction is provided. The method may include providing an educational kit comprising: a circular base; at least one first contoured shaped section with at least one end configured with at least one matching geometry; at least one second contoured shaped section with at least one end configured with at least one universal joining geometry; wherein the at least first contoured shaped section and the at least one second contoured shaped section are configured to mimic at least one portion of a plasmid; at least one audio circuit; at least one visual circuit; wherein the at least first contoured shaped section and the at least second contoured shaped section contain at least a portion of the at least one audio circuit and the at least one visual circuit; the circular base configured to support the at least one first contoured shaped section and the at least one second contoured section joined to one another; when joined, the at least one first contoured shaped section and the at least one second contoured shaped section complete at least one of the audio circuit or the visual circuit; and providing at least one set of instructions that direct how to form a plasmid construct via placing the at least one first contoured shaped section and the at least one second contoured shaped section onto the circular base in a predetermined order. Further, configuring the audio circuit provides a positive affirmation for correct assembly of the at least one first contoured shaped section and the at least second contoured shaped section and a negative indication for incorrect assembly of the at least one first contoured shaped section and the at least second contoured shaped section. Still yet, the video circuit may be configured to provide a positive indication for correct assembly and a negative indication for incorrect assembly. Furthermore, at least one third contoured shaped section may be configured to have at least one first end with at least one matching geometry and at least one second end with at least one universal joining geometry. Still yet, the base may be configured to contain at least another portion of the at least one audio circuit and the at least one visual circuit. Additionally, the at least one audio circuit may be configured to provide an auditory explanation of a particular plasmid portion represented by the at least one first contoured shaped section or the at least one second contoured shaped section when placed upon the circular base.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a schematic representation of an interactive educational device of the current disclosure.

FIGS. 2A, 2B, 2C, and 2D show a plurality of component parts of an educational device cut into different contour shaped sections.

FIG. 3 shows a circuit diagram of an educational device according to the present disclosure.

FIG. 4 shows a photograph of an educational device of the present disclosure with the visual circuit activated.

FIG. 5 shows a partially disassembled educational device of the current disclosure.

FIG. 6 shows an assembled educational device of the current disclosure.

FIG. 7 shows one embodiment of a completely disassembled educational device of the current disclosure.

FIG. 8 shows one embodiment of a model of a plasmid.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

As used interchangeably herein, the terms “sufficient” and “effective,” can refer to an amount (e.g. mass, volume, dosage, concentration, and/or time period) needed to achieve one or more desired and/or stated result(s). For example, a therapeutically effective amount refers to an amount needed to achieve one or more therapeutic effects.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

Kits

Any of the devices described herein can be presented as a combination kit. As used herein, the terms “combination kit” or “kit of parts” refers to the educational tools, compositions, and any additional components that are used to package, sell, market, deliver, and/or provide and use the educational aid. Such additional components include, but are not limited to, packaging, blister packages, bottles, containers, and the like. When one or more of the educational devices described herein or a combination thereof (e.g., items contained in the kit are administered simultaneously, the combination kit can contain the educational device in one package or made available as multiple packages. When the educational devices described herein or a combination thereof and/or kit components are not provided simultaneously, the combination kit can contain each component separately. The separate kit components can be contained in a single package or in separate packages within the kit.

In some embodiments, the combination kit also includes instructions printed on or otherwise contained in a tangible medium of expression. The instructions can provide information regarding the content of the educational device and its components, safety information regarding the content of the compounds and formulations (e.g., device materials), information regarding the assembly and instructions for use. In some embodiments, the instructions can provide directions and protocols for using the educational device and providing teaching instruction with same.

The present disclosure is an interactive educational device that helps in the conceptual understanding of the structure and function of a very important molecular biology tool, the plasmid. This disclosure recreates the structure of a plasmid in the form of a physical device that can be accessed widely due to its light weight and portable nature. It simultaneously provides a conceptual, comprehensive and clear understanding of the various structural and functional components of the versatile molecular biology tool, the plasmid.

This product is different because it is an interactive educational device, a physical entity of a biological tool, a plasmid that is easy to use and understand, it is inexpensive, light weight and ergonomically designed and can be used even by the visually impaired population.

The main advantage of the present disclosure lies in that, through its constant use, it enables a knowledge seeker to learn the basic and fundamental structure and function of a molecular biology tool, the plasmid.

DNA or Deoxyribonucleic acid are biomolecules present in all living organisms except for a few primitive lifeforms such as viruses. They comprise a chain of four different nucleotides (sugar+phosphate+nitrogen) named A, T (or U), G, C. Each chain of nucleotide or sequence is unique and encrypts specific sets of instruction(s) such as instructions for our eye color, skin color, intelligence, etc. After the discovery of the DNA double helix in the late 1960s, we started learning more about these sequences and the information they encode. This, in turn, gave rise to a new branch of science called recombinant DNA technology.

In humans and other multicellular organisms, DNA sequences are billions of base pairs in length and organized in a supercoiled structure called a chromosome. When required, these chromosomes are uncoiled at specific locations to produce proteins of interest. Proteins are the functional biomolecules encoded by DNA that perform the desired function. Because of its enormous length and spatio-temporal activation, it is nearly impossible to understand the encrypted information by the DNA.

Interestingly, some extrachromosomal circular DNA is present in bacteria, called plasmids. These DNA sequences are extremely simplified versions of the chromosome. Like a DNA sequence in a chromosome, plasmids can make exact copies of themselves without any mistakes and produce specific proteins important for the survival of bacteria in certain stress conditions. With a greater understanding of the plasmids, now we can replace certain parts of the plasmid DNA with a DNA sequence from a human or any other living organism to identify the protein it encodes and the functions it performs.

Plasmids are integral components of every branch of biology for laboratories working on basic or translational sciences. Plasmids are an indispensable tool to learn and assign a function to a piece of DNA, assign a function to different proteins, and ultimately use it in medical and non-medical science research to improve the quality of life of human beings.

A molecular biologist understands the structure and function of each part of the plasmid. They know how to engineer those plasmids to assign functions to unknown pieces of DNA or to express known and unknown proteins, incorporate green fluorescent proteins or other protein tags to track those proteins in the living system.

However, it is a complex and complicated entity for behavioral scientists, plant scientists, and other scientists from a variety of fields who do not have training in molecular biology but still need to understand the molecular mechanism of the scientific questions they wish to answer. More importantly, it is a very complex and challenging topic for high school students and science teachers. To make this topic simpler and easier to understand, we came up with this disclosure—a physical model of a plasmid.

A plasmid is a small, extrachromosomal DNA molecule within a cell that is physically separated from chromosomal DNA and can replicate independently. They are most commonly found as small circular, double-stranded DNA molecules in bacteria; however, plasmids are sometimes present in archaea and eukaryotic organisms. In nature, plasmids often carry genes that benefit the survival of the organism and confer selective advantage such as antibiotic resistance. While chromosomes are large and contain all the essential genetic information for living under normal conditions, plasmids are usually very small and contain only additional genes that may be useful in certain situations or conditions. Artificial plasmids are widely used as vectors in molecular cloning, serving to drive the replication of recombinant DNA sequences within host organisms. In the laboratory, plasmids may be introduced into a cell via transformation. Synthetic plasmids are available for procurement over the internet.

Due to their artificial nature, lab plasmids are commonly referred to as “vectors” or “constructs.” To insert a gene of interest into a vector, scientists may utilize one of a variety of cloning methods (restriction enzyme, ligation independent, Gateway, Gibson, etc.). The cloning method is ultimately selected based on the plasmid one wants to clone into. Regardless, once the cloning steps are complete, the vector containing the newly inserted gene is transformed into bacterial cells and selectively grown on antibiotic plates.

Importantly, because the bacteria from which plasmids are isolated grow quickly and make more of the plasmids as they grow, scientists can easily make large amounts of plasmid to manipulate and use in later work.

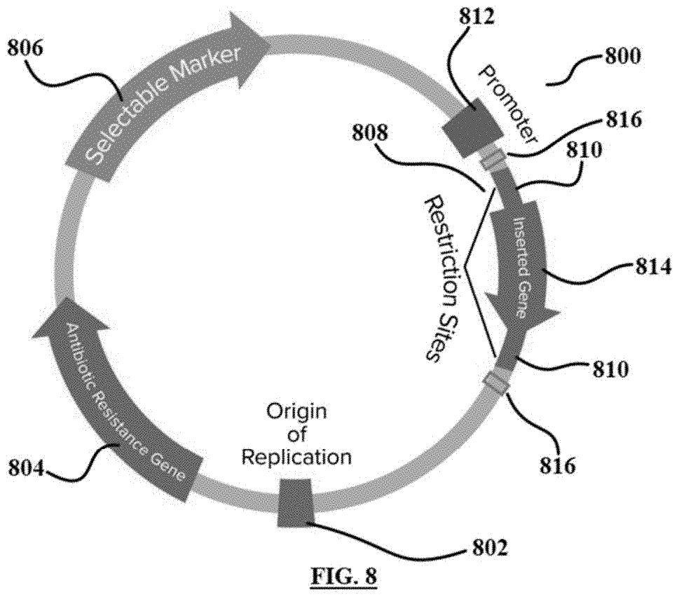

FIG. 8 shows a map 800 of an example plasmid with constituent elements. These elements may include Origin of Replication (ORI) DNA sequence 802 which allows initiation of replication within a plasmid by recruiting replication machinery proteins. The map may also include Antibiotic Resistance Gene 804 that allows for selection of plasmid-containing bacteria. The antibiotic resistance gene allows for selection in bacteria. However, many plasmids also have selectable markers for use in other cell types. Selectable marker 806 may also be present. Selectable marker 808 may be a type of marker gene generally located in the plasmid. It is transformed into the host cell with the help of the plasmid. The transformants that contain the selectable marker can grow in the corresponding selectable medium. The non-transformants, which lack the selectable marker, cannot grow in that selectable medium. Multiple Cloning Site (MCS) 808 may be a short segment of DNA which contains several restriction sites 810 allowing for the easy insertion of DNA. In expression plasmids, the MCS 808 is often downstream from a promoter 812. Further, inserted gene 814 may be a gene, promoter or other DNA fragment cloned into MCS 808 for further study. Promoter region 812 drives transcription of the target gene. It is a vital component for expression vectors and determines which cell types the gene is expressed in and amount of recombinant protein obtained. Primer binding sites 816 may be a short single-stranded DNA sequence used as an initiation point for PCR amplification or sequencing. Primer binding sites 816 can be exploited for sequence verification of plasmids.

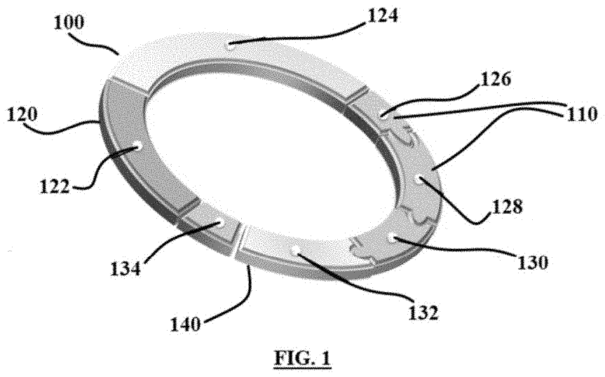

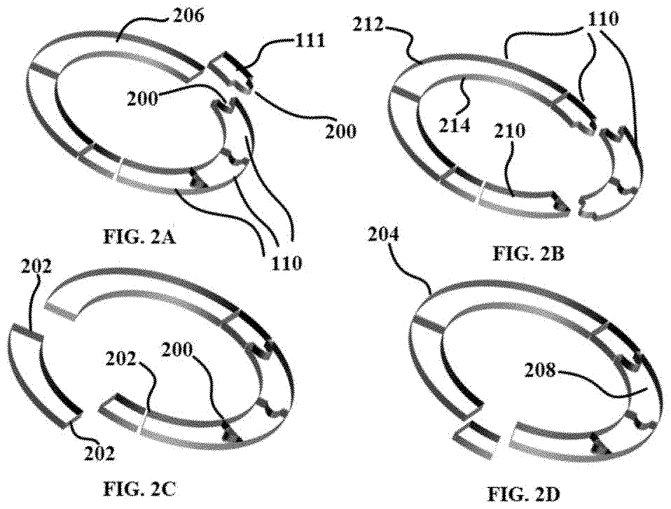

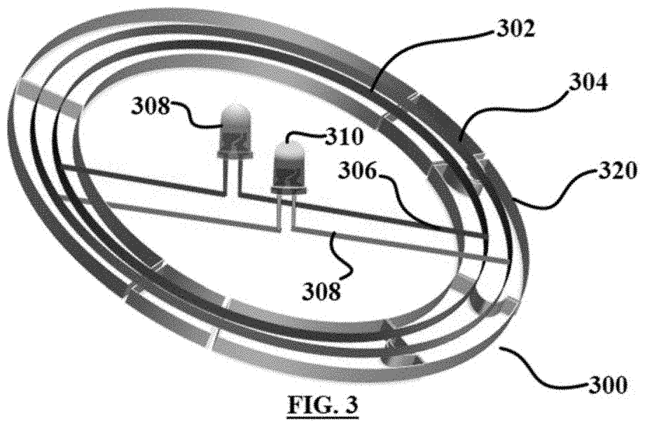

FIG. 1 is a schematic diagram of an educational aid according to the present disclosure. FIGS. 2A, 2B, 2C and 2D represent a plurality of component parts cut into different contour shaped sections. FIG. 3 is a circuit diagram of an educational aid according to the present disclosure, in particular a plasmid tool.

The present disclosure generally relates to an educational aid, an interactive device pertaining to education, for disseminating and communicating scientific concepts. This disclosure more particularly relates to an interactive educational tool plasmid 100 for the study of molecular biology concepts. In the present embodiment, the educational aid/tool 100 operates to convey a scientific concept to the knowledge seekers.

FIG. 1 generally illustrates a schematic representation of an interactive educational aid such as a plasmid. The interactive educational aid 100 comprises a plurality of component parts 110, which is supported on top of at least one base 120. The said educational aid/tool 100 functionally operates in the form of a jigsaw puzzle, wherein all the plurality of the component parts 110 have to be placed and aligned in the correct order for it to illuminate and convey the message to the knowledge seekers that the order of placement is accurate. A second level of affirmation may be established via audio or visual outputs that provide affirmative or negative feedback to the user, such as not lighting or providing a different colored light if the plasmid is incorrectly assembled. As FIG. 1 shows, educational aid 110 mimics the areas found on a laboratory plasmid, see FIG. 8, such as antibiotic resistance gene portion 122, selectable marker portion 124, promoter portion 126, insert portion 128, tag portion 130, wherein insert portion 128 and tag portion 130 may be interchanged with one another, termination portion 132, and/or origin of replication portion 134.

FIGS. 2A, 2B, 2C and 2D represent the plurality of component parts 110 cut into different contour shaped sections 111. Contour shaped sections 111 may be formed in a wide variety of shapes with the ends of each shaped section employing paired or matched engagement, such as male female engagement edges that affix to one another, via matching geometries 200 that can mate with only one another and will not engage with other sections 111. Further, sections that may be universally inserted in the plasmid educational aid/tool 100 may terminate universally joining geometries 202, such as flat edges, curves, etc., that may match with a host of pieces, including sections 111 that have one matching geometry end 200 and one universally joining geometry 202. Thus, three shapes are possible to allow for complimentary joining of sections and to show the various interrelations of portions of a working plasmid construct. One piece such as first section 206 with universally joining geometry 202 on both ends of first section 206, second section 208 having a matching geometry 200 located on each end of second section 208, and third section 210 that has one end with a universally joining geometry 202 and one end with a matching geometry 200. These segment combinations allow for simple way for a researcher or student to learn the various portions of a plasmid.

The shaped sections 111 show which sections of a plasmid may associate freely, such as via their having universally joining geometries, and which sections of the plasmid are dually restricted in placement as each end has a matching geometry that must correspond to an adjoining section 111, as well as shows sections of the plasmid that have one end that may freely match various other sections but one end has a matching geometry that must correspond to another segments matching geometry to allow the sections 111 to join one another. The said contour shaped sections 111 of the plurality of component parts 110 may be cut in such a manner that their outer peripheries 212 and inner peripheries 214 are smooth edged and form a closed loop circle 204 to mimic the physical appearance of a laboratory plasmid.

While matching geometry ends 200 are shown as “puzzle piece” in appearance and universally joining geometry ends 202 are shown as having flat edges, the current disclosure is not so limited as multiple shapes and shape combinations are considered disclosed herein. Indeed, multiple matching geometries may be employed such as puzzle pieces on some ends and male/female engagement such, as a prong/receptor, meshing gears, outlet/inlet formations, etc., on other pieces such that multiple matching geometries are employed in the same closed loop circle 204 to prevent improper joining of sections 111 in ways that are not allowed via plasmid biology.

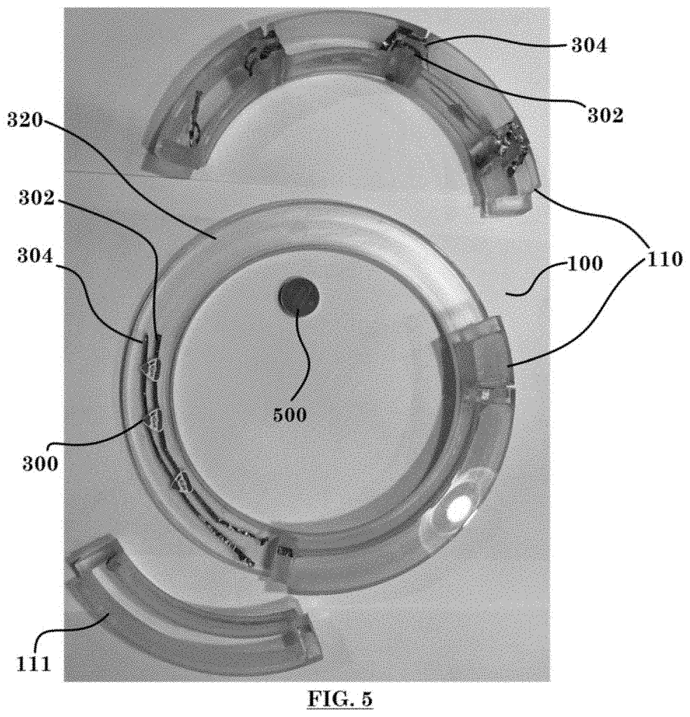

FIG. 3 is a circuit diagram 300 of educational aid 100 according to the present disclosure, in particular the plasmid tool. The present disclosure is equipped with at least two circuits; at least one audio circuit 302 for an audio effect and at least one visual circuit 304 for allowing a visual effect to take place. The audio effect may be a positive or negative indication of plasmid construction success and the video effect may also be a positive or negative indication of plasmid construction success. The at least one sound circuit 302 has sound circuitry 306 and visual circuit 304 also includes visual circuitry 308. Sound circuitry 306 may be powered, such as via a battery 500, see FIG. 5, enclosed within base 320 or sections 111 or other appropriate power source as known to those of skill in the art, and may be attached to an audio signal 308, such as a buzzer, siren, bell, etc., that may produce at least two sounds: one for a positive plasmid formation and one for a negative plasmid formation wherein the positive plasmid formation sound indicates the plasmid is assembled correctly and the negative plasmid formation sound indicates the plasmid is incorrectly assembled. Visual circuit 304 may include at least two visual indicators such as a first colored light for indicating a positive plasmid assembly and a second, differently colored light for indicating a negative plasmid assembly.

Sound circuitry 306 and light circuitry 308 may be embedded into base 320 or contained completely within sections 111, such that a video or audio circuit is completed when sections 111 are joined to one another. Further, sound circuitry 306 and light circuitry 308 may also be found in both base 320 and sections 111, such that a circuit is formed when base 320 and sections 111 are placed in contact with one another. When sections 111 are placed in the accurate position on the at least one base 320, the at least one sound circuit 302 is completed and, in one instance, a pre-recorded audio message from the built-in audio signal 308 describing the name and the function of that particular plurality of component part is conveyed to the knowledge seeker. This process may be continued until all appropriate sections 111 necessary to correctly construct a plasmid are placed on base 320. Upon completion of accurate placement and alignment of the plurality of sections 111, the at least one visual circuit 304 is complete, and the light indicating a correctly/positively assembled plasmid may be illuminated. This re-affirms the knowledge seeker about the correctness of the placements of all the plurality of component sections 111 and their alignment in the protoplasmid construct 140, see FIG. 1.

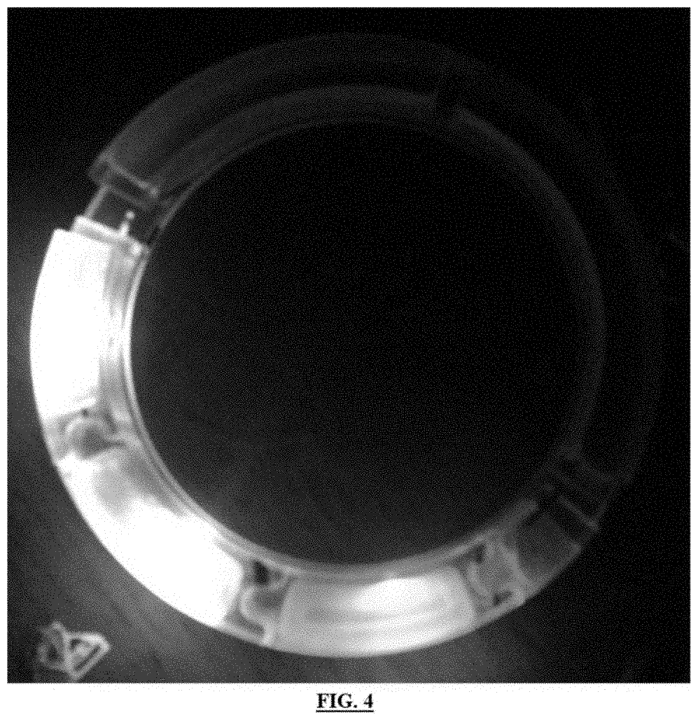

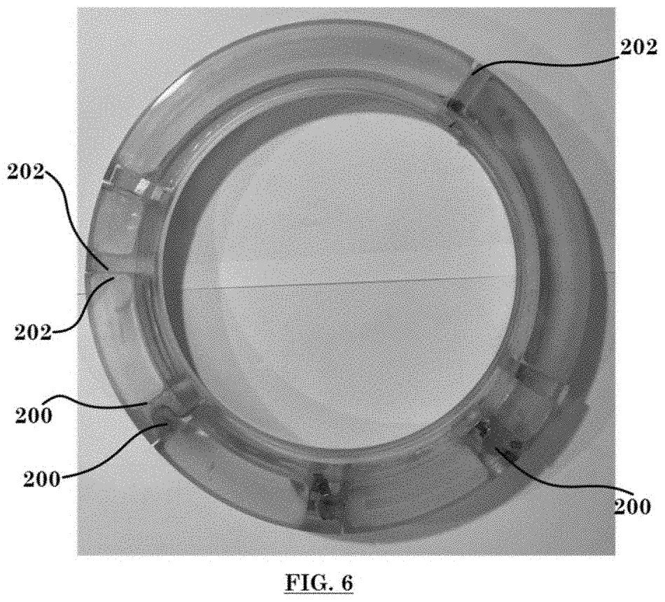

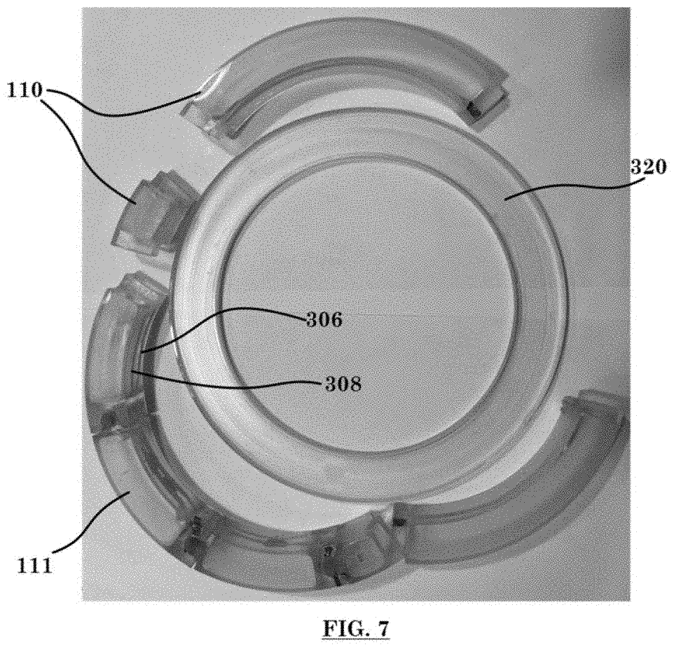

FIG. 4 shows a photograph of an educational device of the present disclosure with light circuitry 308 activated. FIG. 5 shows a partially disassembled educational device 100 of the current disclosure with sound circuitry 306 and light circuitry 308 in base 320 and sections 111. FIG. 6 shows an assembled educational device of the current disclosure illustrating one possible combination of sections 111 to form a protoplasmid construct showing sections 111 with ends having universally joining geometry 202 and/or sections 111 having ends with matching geometry 200. FIG. 7 shows one embodiment of a completely disassembled educational device of the current disclosure with sound circuitry 306 and light circuitry 308 contained only within sections 111.

### EXAMPLE

Now having described the embodiments of the present disclosure, in general, the following Example describes some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure. The following example is put forth to provide those of ordinary skill in the art with a complete disclosure and description of how to perform the methods and use the probes disclosed and claimed herein.

The described educational device may typically look like a ring comprised of a varied number of “puzzle pieces.” Each ring piece represents a functional unit of a plasmid, and each unit has its own function. The units or sections can have labels such as the origin of replication, promoter, polyA tail, Tag protein (e.g., Green fluorescent protein), a gene of interest, and antibiotic resistance gene. Each section (puzzle piece) will have an electric circuit, and the unit representing the gene of interest (or a part of DNA to be studied) will have led lights that may activate when the plasmid is correctly and/or incorrectly formed.

A classroom or research laboratory intended to teach recombinant technology can use this simple educational device to clarify plasmid concepts and how plasmids function. An instructor or student(s) can follow the instructions supplied with the packet to arrange the puzzle pieces. Completing the puzzle (representing the DNA sequence order of a plasmid) will complete the circuit, and the puzzle piece representing a gene of interest and the tagged protein will glow, provide an audio response, etc.

In one embodiment, any deviation in the arrangement of the puzzle pieces will not complete the circuit correctly, and the device will not light up or may light up in a manner indicating an incorrect plasmid structure. This enforces the importance of the order of the DNA sequence in the plasmid. This device will be a game-changing educational device to introduce the topic of recombinant DNA technology to high school students, college/university students, and scientists with limited exposure to molecular biology.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. An interactive plasmid-based educational device comprising:
a circular base;
at least one first contoured shaped section having at least one end configured with at least one matching geometry;
at least one second contoured shaped section having at least one end configured with at least one universal joining geometry;
wherein the at least first contoured shaped section and the at least one second contoured shaped section are configured to mimic at least one portion of a plasmid;
at least one audio circuit;
at least one visual circuit;
wherein the at least first contoured shaped section and the at least second contoured shaped section contain at least a portion of the at least one audio circuit and the at least one visual circuit;
the circular base configured to support the at least one first contoured shaped section and the at least one second contoured section joined to one another; and
wherein when joined, the at least one first contoured shaped section and the at least one second contoured shaped section complete at least one of the audio circuit or the visual circuit.

2. The interactive plasmid-based educational device of claim 1, further comprising wherein the audio circuit provides a positive indication for correct assembly of the at least one first contoured shaped section and the at least second contoured shaped section and the audio circuit provides a negative indication for incorrect assembly of the at least one first contoured shaped section and the at least second contoured shaped section.

3. The interactive plasmid-based educational device of claim 1, further comprising wherein the video circuit provides a positive indication for correct assembly of the at least one first contoured shaped section and the at least second contoured shaped section and the audio circuit provides a negative indication for incorrect assembly of the at least one first contoured shaped section and the at least second contoured shaped section.

4. The interactive plasmid-based educational device of claim 1, further comprising at least one third contoured shaped section having at least one first end with at least one matching geometry and at least one second end with at least one universal joining geometry.

5. The interactive plasmid-based educational device of claim 1, further comprising the base also contains at least another portion of the at least one audio circuit and the at least one visual circuit.

6. The interactive plasmid-based educational device of claim 1, further comprising the at least one audio circuit providing an auditory explanation of a particular plasmid portion represented by the at least one first contoured shaped section or the at least one second contoured shaped section when placed upon the circular base.

7. A method for instruction regarding plasmid construction comprising:
providing an educational kit comprising:
a circular base;
at least one first contoured shaped section having at least one end configured with at least one matching geometry;
at least one second contoured shaped section having at least one end configured with at least one universal joining geometry;
wherein the at least first contoured shaped section and the at least one second contoured shaped section are configured to mimic at least one portion of a plasmid;
at least one audio circuit;
at least one visual circuit;
wherein the at least first contoured shaped section and the at least second contoured shaped section contain at least a portion of the at least one audio circuit and the at least one visual circuit;
the circular base configured to support the at least one first contoured shaped section and the at least one second contoured section joined to one another;
wherein when joined, the at least one first contoured shaped section and the at least one second contoured shaped section complete at least one of the audio circuit or the visual circuit; and
providing at least one set of instructions, wherein the at least one set of instructions direct how to form a plasmid construct via placing the at least one first contoured shaped section and the at least one second contoured shaped section onto the circular base in a predetermined order.

8. The method for instruction regarding plasmid construction of claim 7, further comprising providing via the audio circuit a positive indication for correct assembly of the at least one first contoured shaped section and the at least second contoured shaped section and providing via the audio circuit a negative indication for incorrect assembly of the at least one first contoured shaped section and the at least second contoured shaped section.

9. The method for instruction regarding plasmid construction of claim 7, further comprising providing via the video circuit a positive indication for correct assembly of the at least one first contoured shaped section and the at least second contoured shaped section and providing via the audio circuit a negative indication for incorrect assembly of the at least one first contoured shaped section and the at least second contoured shaped section.

10. The method for instruction regarding plasmid construction of claim 7, further comprising configuring at least one third contoured shaped section with at least one first end with at least one matching geometry and at least one second end with at least one universal joining geometry.

11. The method for instruction regarding plasmid construction of claim 7, further comprising configuring the base to contain at least another portion of the at least one audio circuit and the at least one visual circuit.

12. The method for instruction regarding plasmid construction of claim 7, further comprising configuring the at least one audio circuit to provide an auditory explanation of a particular plasmid portion represented by the at least one first contoured shaped section or the at least one second contoured shaped section when placed upon the circular base.
